(19) United States
(12) Patent Application Publication
(10) Pub. No.: US 2017/0174711 A1
(43) Pub. Date: Jun. 22, 2017

(54) ACID GENERATOR AND COMPOSITION

(71) Applicant: TOYO GOSEI CO., LTD., Chiba (JP)

(72) Inventors: Takashi MIYAZAWA, Chiba (JP); Yuki TOMA, Chiba (JP)

(73) Assignee: TOYO GOSEI CO., LTD., Chiba (JP)

(21) Appl. No.: 15/381,310

(22) Filed: Dec. 16, 2016

Related U.S. Application Data
(60) Provisional application No. 62/268,293, filed on Dec. 16, 2015.

(51) Int. Cl. C07F 7/08; C08G 59/40

(52) U.S. Cl. CPC C07F 7/0818; C08G 59/4085

(57) ABSTRACT

Acid generators and compositions are disclosed. Such acid generators and compositions are applicable to functional materials such as adhesives, sealant or antireflection coating (ARC).

### CROSS-REFERENCE TO RELATING APPLICATION

This application claims the benefit under 35 U.S.C. §119(e) of U.S. Provisional Patent Application Ser. 62/268,293 filed on Dec. 16, 2015, the disclosure of which is hereby incorporated herein in its entirety by these references.

### TECHNICAL FIELD

Several aspects of the present invention relate to the fields of acid generator by heating or photoirradiation. Several aspects of the present invention relate to compositions applicable to functional materials such as adhesives, sealant, antireflection coating (ARC) or photoresist.

### BACKGROUND

Thermal acid generator suitable for anti-reflective film is disclosed in JP 2012-128436 (laid-open disclosure date: Jul. 5, 2012).

### BRIEF SUMMARY

A compound relating to an aspect of the present invention includes: a cation having a first hetero atom of group 14 element and a second hetero atom of group 15 element, group 16 element or group 17 element; and an anion. Examples of the first hetero atom are silicon, germanium, tin and lead. Examples of the second hetero atom for group 15 element are nitrogen, phosphorus, arsenic, antimony and bismuth. Examples of the second hetero atom for group 16 element are oxygen, sulfur, selenium, tellurium and polonium. Examples of the second hetero atom for group 17 element are fluorine, chlorine, bromine, iodine and astatine.

With regard to the compound, it is preferred that the cation further includes an aryl group. Examples of such aryl group are phenyl, naphthyl, phenanthryl, anthryl, pyrenyl, chrysenyl, triphenylenyl, biphenyl and terphenyl.

With regard to any one of the compounds, it is preferred that the first hetero atom is bonded to the aryl group through a first carbon atom.

With regard to any one of the compounds, it is preferred that the cation is an onium ion. Typical examples of such onium are sulfonium ion, iodonium ion and ammonium ion.

With regard to any one of the compounds, it is preferred that the cation is any one of a sulfonium ion and an ammonium ion.

With regard to any one of the compounds, it is preferred that the second hetero atom forms four bonds when the second hetero atom is group 15 element; the second hetero atom forms three bonds when the second hetero atom is group 16 element; and the second hetero atom forms two bonds when the second hetero atom is group 17 element.

With regard to any one of the compounds, it is preferred that the second hetero atom is bonded to the first carbon atom.

With regard to any one of the compounds, it is preferred that: the cation further includes an aryl group; and the second hetero atom is bonded to the aryl group. Examples of such aryl group are phenyl, naphthyl, phenanthryl, anthryl, pyrenyl, chrysenyl, triphenylenyl, biphenyl and terphenyl.

With regard to any one of the compounds, it is preferred that the second hetero atom forms four bonds when the second hetero atom is group 15 element; the second hetero atom forms three bonds when the second hetero atom is group 16 element; and the second hetero atom forms two bonds when the second hetero atom is group 17 element.

With regard to any one of the compounds, it is preferred that the first hetero atom is bonded to the aryl group through a second carbon atom.

With regard to any one of the compounds, it is preferred that: the second hetero atom is bonded to a third carbon atom of the aryl group; and the second carbon atom is bonded to a fourth carbon atom of the aryl group.

With regard to the compound, it is preferred that the aryl group is a phenyl group; and the fourth carbon atom is positioned at para position of the third carbon atom.

With regard to any one of the compounds, it is preferred that the first hetero atom is a silicon atom.

With regard to any one of the compounds, it is preferred that the compound generates acid by at least one of heating, photoirradiation and exposure to particle beam.

With regard to any one of the compounds, it is preferred that the anion includes an oxygen atom. Such anion is able to assist decomposition of the cation by an interaction between such oxygen atom and the first hetero atom.

With regard to any one of the compounds, it is preferred that the anion is trifluoromethane sulfonate or nonafluorobutane sulfonate. Such anion includes at least one oxygen atom. The number of the oxygen atom included in the anion is preferably 10 or less, more preferably 6 or less, and further more preferably 4 or less.

With regard to any one of the cations, it is preferred that such cation has a substituent containing group 16 element on an aryl group and an atom of group 14 element bonded to the aryl group through a carbon atom.

A concrete example for such cation may be a sulfonium cation expressed by the following chemical formula (I):

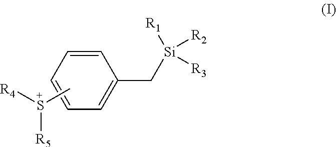

In the above chemical structure, each of R₁, R₂, R₃, R₄ and R₅ is independently an alkyl group, an alkenyl group, an alkynyl group and an aryl group each of which may not have independently any substituent or may have independently at least one substituent containing at least one hetero atom.

It is preferred that at least one of four atoms bonded to the silicon atom is an atom other than an oxygen atom because of improvement to moisture. The number of a carbon atom included in each R₁, R₂, R₃, R₄ and R₅ is preferably 20 or less, and more preferably 12.

Any one of R₁, R₂, R₃, R₄ and R₅ may be bonded to a main chain of a polymer or a side chain of a polymer.

With regard to the cation, it is preferred that such cation has an atom of group 16 element and an atom of group 14 element bonded to an identical carbon atom.

A concrete example for such cation may be a sulfonium cation expressed by the following chemical formula (II).

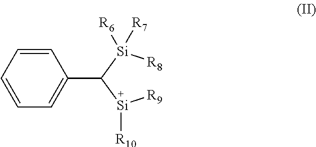

In the above chemical structure, each of R₆, R₇, R₈, R₉ and R₁₀ is independently an alkyl group, an alkenyl group, an alkynyl group and an aryl group each of which may not have independently any substituent or may have independently at least one substituent containing at least one hetero atom. It is preferred that at least one of R₆, R₇, R₈, R₉ and R₁₀ has at least two carbon atoms because improvement of solubility in monomer or solvent. The number of the carbon atom included in each R₆, R₇, R₈, R₉ and R₁₀ is preferably 20 or less, and more preferably 12.

Any one of R₆, R₇, R₈, R₉ and R₁₀ may be bonded to a main chain of a polymer or a side chain of a polymer.

With regard to the cation, it is preferred that such cation has a substituent containing group 15 element on an aryl group and an atom of group 14 element bonded to the aryl group through a carbon atom.

A concrete example for such cation may be an ammonium cation expressed by the following chemical formula (III):

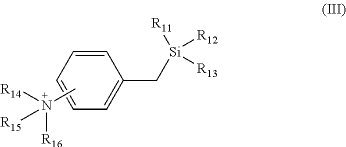

In the above chemical structure, each of R₁₁, R₁₂, R₁₃, R₁₄, R₁₅ and R₁₆ is independently an alkyl group, an alkenyl group, an alkynyl group and an aryl group each of which may not have independently any substituent or may have independently at least one substituent containing at least one hetero atom.

It is preferred that at least one of R₁₁, R₁₂, R₁₃, R₁₄, R₁₅ and R₁₆ has at least two carbon atoms because improvement of solubility in monomer or solvent. The number of the carbon atom included in each R₁₁, R₁₂, R₁₃, R₁₄, R₁₅ and R₁₆ is preferably 20 or less, and more preferably 12.

Any one of R₁₁, R₁₂, R₁₃, R₁₄, R₁₅ and R₁₆ may be bonded to a main chain of a polymer or a side chain of a polymer.

With regard to the cation, it is preferred that such cation has an atom of group 15 element or an atom of group 14 element bonded to an identical carbon atom.

A concrete example for such cation may include an ammonium cation expressed by the following chemical formula (IV):

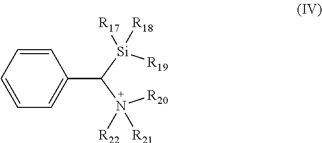

In the above chemical structure, each of R₁₇, R₁₈, R₁₉, R₂₀, R₂₁ and R₂₂ is independently an alkyl group, an alkenyl group, an alkynyl group and an aryl group each of which may not have independently any substituent or may independently have at least one substituent containing at least one hetero atom. It is preferred that at least one of R₁₇, R₁₈, R₁₉, R₂₀, R₂₁ and R₂₂ has at least two carbon atoms because improvement of solubility in monomer or solvent. The number of the carbon atom included in each R₁₇, R₁₈, R₁₉, R₂₀, R₂₁ and R₂₂ is preferably 20 or less, and more preferably 12.

Any one of R₁₇, R₁₈, R₁₉, R₂₀, R₂₁ and R₂₂ may be bonded to a main chain of a polymer or a side chain of a polymer.

A composition relating to an aspect of the present invention includes: any one of the above compound and a monomer or a compound with at least one polymerizable group.

With the regard to the composition, it is preferred that such monomer is able to polymerize by acid.

With the regard to the composition, it is preferred that such compound with at least one polymerizable group is able to polymerize by acid. Typical examples of such polymerizable group are epoxy, vinyl ether and oxetane groups.

A composition relating to an aspect of the present invention is applicable to functional materials such as adhesives, sealant, antireflection coating (ARC) or photoresist. An ARC film is usually formed before formation of a photoresist film to be formed on the ARC film.

Such composition may include a compound containing a silicon atom. Typically, such compound has a silicon-oxygen bond. When such composition is applied to ARC, it is preferred that such composition a moiety absorbing a light such as aromatic group.

A device such as semiconductor device and electro-optical device can be manufactured by a composition relating to an aspect of the present invention.

### BRIEF DESCRIPTION OF THE DRAWINGS

In the drawings, which illustrate what is currently considered to be the best mode for carrying out several aspects of the present invention:

FIG. 1 shows the method for evaluation of sensitivities for compositions each of which contains Compounds A, B, C, D and E as a thermal acid generator (TAG).

FIG. 2 shows the method for evaluation of sensitivities for compositions each of which contains Compounds A, B, C, D and E as a photoacid generator (PAG).

### DETAILED DESCRIPTION

### Experimental Procedures

Synthesis of Compounds A, B, C, D and E

Compounds A-E are synthesized according to the following procedures.

Synthesis of Dimethyl-(4-trimethylsilylmethyl-phenyl)-sulfonium Trifluoro-methanesulfonate (Compound A) is synthesized according to the following procedure.

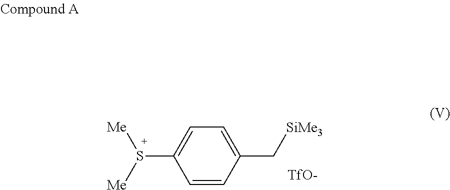

A mixture of 5.0 g of benzyltrimethylsilane and 4.32 g of diphosphorus pentaoxide is cooled to 0 degree Celsius while a mixture of 2.62 g of dimethylsuofoxide and 23.39 g of methanesulfonic acid is a cooled to 0 degree Celsius. The mixture containing dimethylsulfoxide is added to the mixture containing benzyltrimethylsilane dropwise. After the addition of the mixture containing dimetylsulfoxide to the mixture containing benzyltrimethylsilane, the mixture containing dimethylsulfoxide and benzyltrimethylsilane is stirred at 0 degree Celsius for 3 hours. Then the mixture is warmed to 25 degrees Celsius and stirred at 25 degrees Celsius for 1 hour. After cooling of the mixture to 0 degree Celsius, 1.23 g of pure water is added to the cooled mixture. After the addition of diisopropyl ether to the mixture, extraction is carried out to collect the aqueous layer. 11.9 g of dichloromethane and 5.76 g of sodium triflate are added to the collected aqueous layer. The mixture is stirred for 3 hours. Extraction is carried out to collect the organic layer. After evaporation of dichloromethane, crude dimethyl-(4-trimethylsilylmethyl-phenyl)-sulfonium trifluoro-methanesulfonate is obtained. Dimethyl-(4-trimethylsilylmethyl-phenyl)-sulfonium trifluoro-methanesulfonate is obtained as white solid precipitating by addition of an acetonitrile solution of the crude dimethyl-(4-trimethylsilylmethyl-phenyl)-sulfonium trifluoro-methanesulfonate to diisopropyl ether. The white solid is taken by filtering, water-washed, and dried at 40 degrees Celsius for 12 hours.

Synthesis of dimethyl-(trimethylsilyl)(phenyl) methyl-sulfonium trifluoro-methanesulfonate (Compound B) is synthesized according to the following procedure.

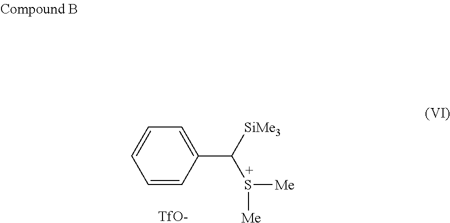

A mixture of 10 ml of benzene, 1.64 g of benzyltrimethylsilane and 1.90 g of N-bromosuccinimide is heated at 85 degrees Celsius for 4 hours with stirring. The mixture is cooled to room temperature and filtered by a filter paper. Evaporation of benzene from the filtrate gives 1.9 g of bromo(phenyl)(trimethylsilyl)methane.

A mixture of 5.0 g of dichloromethane, 1.9 g of bromo(phenyl)(trimethylsilyl)methane and 2.0 g of silver trifluoromethanesulfonate is prepared. 0.8 g of dimethylsulfide is added to the mixture. The mixture is stirred at room temperature for 3 hours. After addition of acetonitrile, the mixture is further stirred for 1 hour. The mixture is filtered by a paper filter. The filtrate is concentrated by evaporation of solvents until the volume of the filtrate reaches one-quarter of the initial volume. Addition of diisopolyl ether to the concentrated filtrate gives dimethyl-(trimethylsilyl)(phenyl)methyl-sulfonium trifluoro-methanesulfonate as white solid. The white solid is taken by filtering, water-washed, and dried at 40 degrees Celsius for 12 hours.

Synthesis of dimethyl-(4-trimethylsilylmethyl-phenyl)-sulfonium Bis(trifluoromethanesulfonyl)imide (Compound C) is synthesized according to the following procedure.

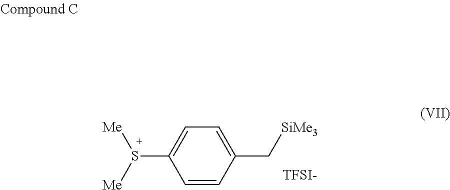

A mixture of 5.0 g of benzyltrimethylsilane and 4.32 g of diphosphorus pentaoxide is cooled to 0 degree Celsius while a mixture of 2.62 g of dimethylsuofoxide and 23.39 g of methanesulfonic acid is cooled to 0 degree Celsius. The mixture containing dimethylsulfoxide is added to the mixture containing benzyltrimethylsilane dropwise. After the addition of the mixture containing dimetylsulfoxide to the mixture containing benzyltrimethylsilane, the mixture containing dimethylsulfoxide and benzyltrimethylsilane is stirred at 0 degree Celsius for 3 hours. Then the mixture is warmed to 25 degrees Celsius and stirred at 25 degrees Celsius for 1 hour. After cooling of the mixture to 0 degree Celsius, 1.23 g of pure water is added to the cooled mixture. After the addition of diisopropyl ether to the mixture, extraction is carried out to collect the aqueous layer. 11.9 g of dichloromethane and 10.69 g of potassium bis(trifluoromethanesulfonyl)imide are added to the collected aqueous layer. The mixture is stirred for 3 hours. Extraction is carried out to collect the organic layer. After evaporation of dichloromethane, crude dimethyl-(4-trimethylsilylmethyl-phenyl)-sulfonium bis(trifluoromethanesulfonyl)imide is obtained. Dimethyl-(4-trimethylsilylmethyl-phenyl)-sulfonium bis(trifluoromethanesulfonyl)imide is obtained as white solid precipitating by addition of an acetonitrile solution of the crude dimethyl-(4-trimethylsilylmethyl-phenyl)-sulfonium bis(trifluoromethanesulfonyl)imide to diisopropyl ether. The white solid is taken by filtering, water-washed, and dried at 40 degrees Celsius for 12 hours.

Synthesis of Dimethyl-(4-trimethylsilylmethyl-phenyl)-sulfonium hexafluorophophate (Compound D) is synthesized according to the following procedure.

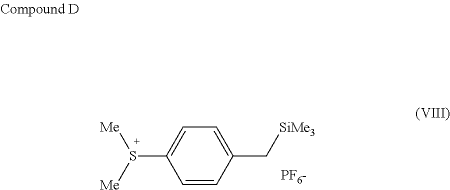

A mixture of 5.0 g of benzyltrimethylsilane and 4.32 g of diphosphorus pentaoxide is cooled to 0 degree Celsius while a mixture of 2.62 g of dimethylsuofoxide and 23.39 g of methanesulfonic acid is cooled to 0 degree Celsius. The mixture containing dimethylsulfoxide is added to the mixture containing benzyltrimethylsilane dropwise. After the addition of the mixture containing dimetylsulfoxide to the mixture containing benzyltrimethylsilane, the mixture containing dimethylsulfoxide and benzyltrimethylsilane is stirred at 0 degree Celsius for 3 hours. Then the mixture is warmed to 25 degrees Celsius and stirred at 25 degrees Celsius for 1 hour. After cooling of the mixture to 0 degree Celsius, 1.23 g of pure water is added to the cooled mixture. After the addition of diisopropyl ether to the mixture, extraction is carried out to collect the aqueous layer. 11.9 g of dichloromethane and 6.70 g of potassium hexafluorophsphate are added to the collected aqueous layer. The mixture is stirred for 3 hours. Extraction is carried out to collect the organic layer. After evaporation of dichloromethane, crude dimethyl-(4-trimethylsilylmethyl-phenyl)-sulfonium hexafluorophsphate is obtained. Dimethyl-(4-trimethylsilylmethyl-phenyl)-sulfonium hexafluorophsphate is obtained as white solid precipitating by addition of an acetonitrile solution of the crude dimethyl-(4-trimethylsilylmethyl-phenyl)-sulfonium hexafluorophsphate to diisopropyl ether. The white solid is taken by filtering, water-washed, and dried at 40 degrees Celsius for 12 hours.

Synthesis of Dimethyl-(4-trimethylsilylmethyl-phenyl)-sulfonium hexafluoroantimonate (Compound E) is synthesized according to the following procedure.

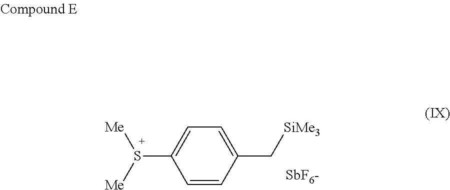

A mixture of 5.0 g of benzyltrimethylsilane and 4.32 g of diphosphorus pentaoxide is cooled to 0 degree Celsius while a mixture of 2.62 g of dimethylsuofoxide and 23.39 g of methanesulfonic acid is added to cooled to 0 degree Celsius. The mixture containing dimethylsulfoxide is added to the mixture containing benzyltrimethylsilane dropwise. After the addition of the mixture containing dimetylsulfoxide to the mixture containing benzyltrimethylsilane, the mixture containing dimethylsulfoxide and benzyltrimethylsilane is stirred at 0 degree Celsius for 3 hours. Then the mixture is warmed to 25 degrees Celsius and stirred at 25 degrees Celsius for 1 hour. After cooling of the mixture to 0 degree Celsius, 1.23 g of pure water is added to the cooled mixture. After the addition of diisopropyl ether to the mixture, extraction is carried out to collect the aqueous layer. 11.9 g of dichloromethane and 9.21 g of potassium hexafluoroantimonate are added to the collected aqueous layer. The mixture is stirred for 3 hours. Extraction is carried out to collect the organic layer. After evaporation of dichloromethane, crude dimethyl-(4-trimethylsilylmethyl-phenyl)-sulfonium hexafluoroantimonate is obtained. Dimethyl-(4-trimethylsilylmethyl-phenyl)-sulfonium hexafluoroantimonate is obtained as white solid precipitating by addition of an acetonitrile solution of the crude dimethyl-(4-trimethylsilylmethyl-phenyl)-sulfonium hexafluoroantimonate to diisopropyl ether. The white solid is taken by filtering, water-washed, and dried at 40 degrees Celsius for 12 hours.

Evaluation of Sensitivity of Compounds A, B, C, D and E as a thermal acid generator (TAG)

Evaluation of sensitivity of the above compounds as TAG or photoacid generator (PAG) is carried out according to the following procedures.

Each of the samples for evaluation of sensitivities as a TAG or PAG (“Evaluation Sample”) is prepared by dissolving any one of Compounds A, B, C, D and E into a monomer having two epoxy groups such that the concentration of such compound for such monomer is 1 wt %. Such monomers are 2,2′-[(dimethylmethylene)bis(4,1-phenyleneoxymethylene)]bisoxirane (Monomer A) and (7-Oxa-bicyclo[4.1.0]heptane-3-carboxylic acid 7-oxa-bicyclo[4.1.0]hept-3-ylmethyl ester) (Monomer B) and, respectively.

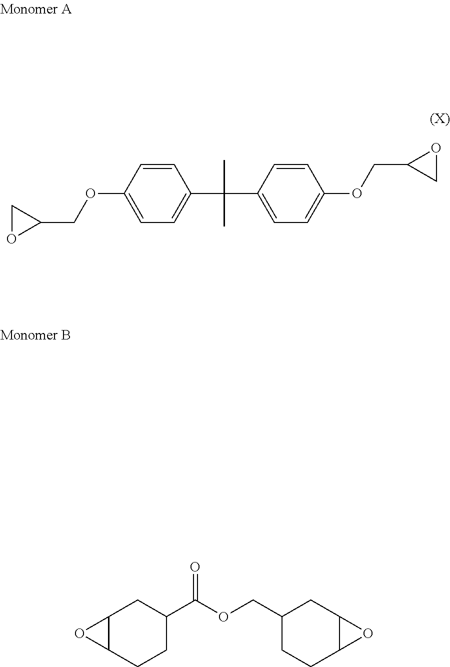 [SMILES: CC(C)(c1ccc(OCC2CO2)cc1)c1ccc(OCC2CO2)cc1 ; O=C(OCC1CCC2OC2C1)C1CCC2OC2C1]

For Evaluation Samples 4 and 5, chloranil and 2, 3 dichloro-5, 6-dicyanoquinone (DDQ) in addition to the TAG are also dissolved into Monomer A in addition to the TAG, respectively. Chloranil and 2, 3 dichloro-5, 6-dicyanoquinone (DDQ) can play roles as oxidizing agents which can receive electrons from a bond between the silicon atom and a carbon atom.

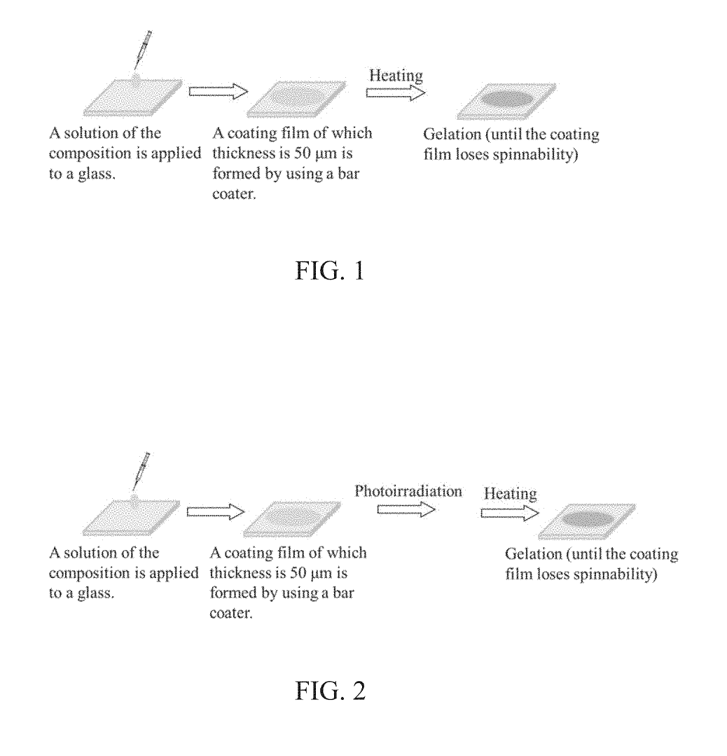

Sensitivities of compositions containing Compounds A, B, C, D and E as TAGs are evaluated in the manner shown in FIG. 1. An Evaluation Sample is applied to a glass. A coating film of such Evaluation Sample is formed by a bar coater such that such coating film has thickness of 50 μm. Time until the coating loses spinnability is measured as a gelation time. The sensitivity is considered to increase in inverse proportion to the gelation time. Table 1 shows gelation times for Evaluation Samples 1-9.

TABLE 1
Gelation times for Evaluation Samples 1-9

| | | | Heating | | |
|---|---|---|---|---|---|
| | | | Temperature/ | | |
| | | | degree | | Gelation |
| | TAG | Monomer | Celsius | Additive | Time/min |
| Evaluation Sample 1 | Compound A | Monomer A | 150 | — | 39 |
| Evaluation Sample 2 | | Monomer B | 150 | — | 4 |
| Evaluation Sample 3 | | Monomer B | 190 | — | 0.75 |
| Evaluation Sample 4 | | Monomer A | 150 | chloranil | 32.5 |
| Evaluation Sample 5 | | Monomer A | 150 | 2,3 dichloro-5,6- | 14 |
| | | | | dicyanoquinone | |
| | | | | (DDQ) | |
| Evaluation Sample 6 | Compound B | Monomer A | 150 | — | 10 |
| Evaluation Sample 7 | Compound C | Monomer A | 150 | — | >60 |
| Evaluation Sample 8 | Compound D | Monomer A | 150 | — | >60 |
| Evaluation Sample 9 | Compound E | Monomer A | 150 | — | 25.5 |

Sensitivities of compositions containing Compounds A, B, C, D and E as PAGs are evaluated in the manner shown in FIG. 2. An Evaluation Sample is applied to a glass. A coating film of such Evaluation Sample is formed by a bar coater such that such coating film has thickness of 50 μm. A photoirradiation of the coating film with a light of which wavelength and energy are 280 nm, respectively, and heating of the coating film at 110 degrees Celsius is carried out after the photoirradiation. Time until the coating loses spinnability is measured as a gelation time. The sensitivity is considered to increase in inverse proportion to the gelation time. Table 2 shows gelation times for Evaluation Samples 10-13.

TABLE 2
gelation times for Evaluation Samples 10-13

| | | | Heating | | |
|---|---|---|---|---|---|
| | | | Temperature/degree | | |
| | | | Celsius after | | Gelation |
| | TAG | Monomer | photoirradiation | Additive | Time/min |
| Evaluation Sample 10 | Compound A | Monomer A | 110 | — | >60 |
| Evaluation Sample 11 | Compound C | Monomer A | 110 | — | >60 |
| Evaluation Sample 12 | Compound D | Monomer A | 110 | — | 1.5 |
| Evaluation Sample 13 | Compound E | Monomer A | 110 | — | 0.16 |

Gelation times observed for Evaluation Samples 1 and 2 are 39 min and 4 min, respectively. This indicates that Compound A, which has a silyl methyl group and a dimethyl sulfonio group on an aromatic group, functions as a TAG even at 150 degrees Celsius and that aliphatic epoxy compound like monomer B is more polymerizable by acid.

Gelation times observed for Evaluation Samples 2 and 3 are 4 min and 0.75 min, respectively. This indicates that heating at higher temperature accelerates acid generation.

Gelation times observed for Evaluation Samples 4 and 5 containing an oxidant are shorter than that for Evaluation Sample 1 containing no oxidant. This indicates that oxidant enhances generation of acid from TAG.

Gelation time observed for Evaluation Sample 6 containing Compound B as a TAG is shorter than that for Evaluation Sample 1. This indicates that compound has a sulfonio group bonded to a carbon atom bonded to silyl group or aryl group generates acid more easily.

Gelation times observed for Evaluation Samples 7 and 8 containing TAGs able to generating acids with greater acid strength compared to Compound A are longer that for Evaluation Sample 1. This indicates that oxygen atom contained in the anion of Compound A enhances cleavage of the bond between the silicon atom and the carbon atom bonded to phenyl group.

Gelation time observed for Evaluation Sample 9 is shorter than that for Evaluation Sample 1. This indicates that TAG able to generating very strong acid such as pentafluoroantimonic acid enhances polymerization of monomer even if such TAG has no oxygen atom.

Gelation times observed for Evaluation Samples 10 and 11 containing trifluoromethane sulfonate and bis(trifluoromethanesulfonyl)imide, respectively, are longer than those for those for Evaluations Samples 12 and 13 containing pentafluorophosphate and petafluoroantimonate, respectively. The gelation time observed for Evaluation Sample 13 is shorter than that for Evaluation Sample 12. This indicates that the sensitivities of such compounds as PAGs are in proportion to acid strength.

The above compositions can be applicable to adhesives, sealant, ARC or photoresist.

Preparation of Composition for ARC

Hydrolytic polymerization of a 1:1 mixture of TA-1 and TA-2 gives polymer OPPS.

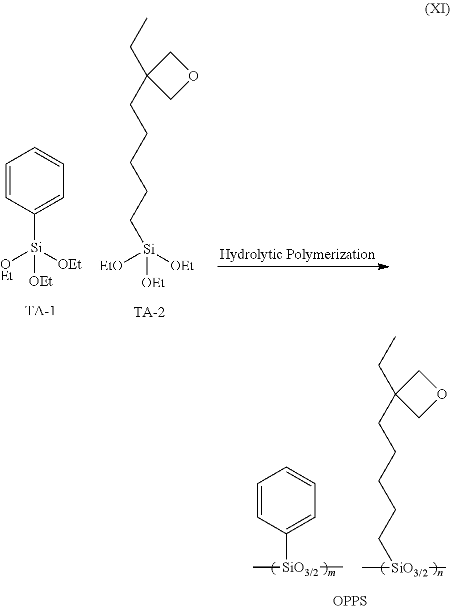

A composition for ARC film is prepared by mixing OPPS of 100 pts. mass with Compound A of 2 pts. mass and propyleneglycol monomethyl ether acetate (PGMEA) of 3000 pts. mass.

The composition is applied on a silicon wafer by a resist coater to form a coating film. The coating film is heated at 190 degrees Celsius for 60 sec to form an ARC film of which thickness is 40 nm.

A composition for resist is applied to the ARC film to form a coating film. The coating film is exposed to a light from an ArF exposure equipment through a mask and is developed to form a pattern of 120 nm in line and space pitch.

The composition for resist contains polymer A (Unit-1:Unit-2:Unit-3=4:4:2; Mw=10000) of 100 pts. mass, PAG-1 of 2 pts. mass, triethanolamine of 0.25 pts. mass and PGMEA of 1000 pts. mass.

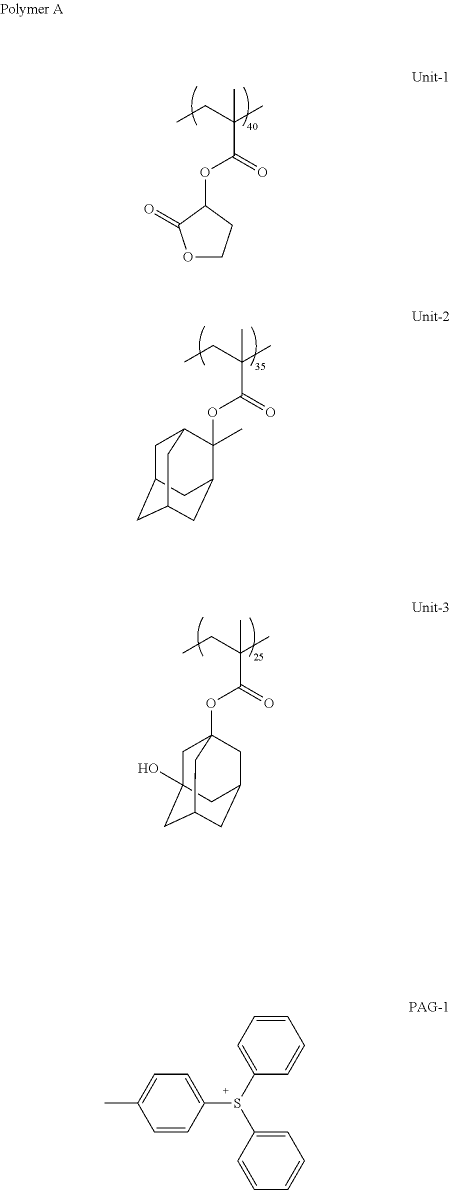

A device such as semiconductor device and electro-optical device can be manufactured by a composition relating to an aspect of the present invention.

What is claimed is:

1. A compound, comprising:
a cation including a first hetero atom of group 14 element and a second hetero atom of group 15 element, group 16 element or group 17 element; and
an anion.

2. The compound of claim 1,
wherein the cation further includes an aryl group.

3. The compound of claim 2,
wherein the first hetero atom is bonded to the aryl group through a first carbon atom.

4. The compound of claim 1,
wherein the cation is an onium ion.

5. The compound of claim 1,
wherein the cation is any one of a sulfonium ion and an ammonium ion.

6. The compound of claim 1,
wherein:
the second hetero atom forms four bonds when the second hetero atom is group 15 element;
the second hetero atom forms three bonds when the second hetero atom is group 16 element; and
the second hetero atom forms two bonds when the second hetero atom is group 17 element.

7. The compound of claim 1,
wherein the second hetero atom is bonded to the first carbon atom.

8. The compound of claim 1,
wherein:
the cation further includes an aryl group; and
the second hetero atom is bonded to the aryl group.

9. The compound of claim 8,
wherein:
the second hetero atom forms four bonds when the second hetero atom is group 15 element;
the second hetero atom three bonds when the second hetero atom is group 16 element; and
the second hetero atom forms two bonds when the second hetero atom is group 17 element.

10. The compound of claim 8,
wherein the first hetero atom is bonded to the aryl group through a second carbon atom.

11. The compound of claim 10,
wherein:
the second hetero atom is bonded to a third carbon atom of the aryl group; and
the second carbon atom is bonded to a fourth carbon atom of the aryl group.

12. The compound of claim 11,
wherein:
the aryl group is a phenyl group; and
the fourth carbon atom is positioned at para position of the third carbon atom.

13. The compound of claim 1,
wherein the first hetero atom is a silicon atom.

14. The compound of claim 1,
wherein the compound generates acid by at least one of heating, photoirradiation and exposure to particle beam.

15. The compound of claim 1,
wherein the anion includes an oxygen atom.

16. The compound of claim 1,
wherein the anion is trifluoromethane sulfonate or nonafluorobutane sulfonate.

17. A composition, comprising:
the compound of claim 1; and
a monomer polymerizable by acid or a polymer having crosslinking groups.

18. The composition of claim 17,
wherein the composition is applicable to adhesives, sealant, antireflection coating (ARC) or photoresist.

19. The composition of claim 17,
wherein:
the monomer includes a silicon atom; and
the polymer includes a silicon atom.

20. A method of manufacturing a device,
wherein the method is carried out using the composition of claim 17.
